(19) United States
(12) Patent Application Publication
(10) Pub. No.: US 2026/0092658 A1
(43) Pub. Date: Apr. 2, 2026

(54) TUBE FOR GUIDING OF CLEANING FLUIDS

(71) Applicant: TI Automotive (Fuldabrueck) GmbH, Fuldabrueck (DE)

(72) Inventors: Siegfried ARNOLD, Kassel (DE); Frank FAHRENHOLZ, Kassel (DE); Martin SCHRAMOWSKI, Kassel (DE); Andre HAECKEL, Waldeck (DE)

(21) Appl. No.: 19/305,652

(22) Filed: Aug. 20, 2025

(30) Foreign Application Priority Data
Aug. 20, 2024 (DE) 102024123781.3

(51) Int. Cl. F16L 11/04

(52) U.S. Cl. CPC F16L 11/045; F16L 2011/047

(57) ABSTRACT

A tube for guiding a cleaning fluid has a tube wall, wherein the tube wall encloses a lumen. The tube wall comprises a polyamide and/or a polyolefin.

### RELATED APPLICATIONS

The present disclosure claims priority to and the benefit of German Application 102024123781.3, filed on Aug. 20, 2024, the entire contents of each of which are incorporated herein by reference.

### FIELD

The present disclosure relates to a tube for conveying a cleaning fluid, wherein the tube has a tube wall, wherein the tube wall encloses a lumen. The present disclosure further relates to a use of such a tube for transporting a cleaning fluid.

### BACKGROUND

A tube for conveying cleaning water is known from CN117813222A. The tube is used to transport the cleaning water from a reservoir to sensors (cameras, radar sensors, lidar sensors) of an Advanced Driver Assistance System (ADAS). This system is used, for example, for partially or even fully autonomous driving of vehicles, in which even temporary impairment of the sensors due to contamination is unacceptable. For this purpose, the sensor or sensors are sprayed with the cleaning fluid as required and then cleaned with compressed air to remove the cleaning fluid and dirt mixture.

The tube from CN117813222A is made of polyurethane and has an inner diameter of 2 mm and an outer diameter of 3 mm. However, we have discovered a disadvantage that the known tubes degrade over time and can become brittle and, under certain circumstances, cracked.

### BRIEF SUMMARY

The present disclosure provides a tube that degrades less over time and is more resistant to cleaning fluids than prior tubes.

This tube according to the present disclosure is for guiding a cleaning fluid, wherein the tube has a tube wall, wherein the tube wall encloses a lumen, and wherein the tube wall comprises a polyamide and/or a polyolefin.

The present disclosure is based on the discovery that ADAS cleaning fluids can contain not only water but also, in particular, an active component in the preferred form of a solvent, and that water-solvent mixtures are particularly preferred for cleaning the sensors. It has been found that the ADAS cleaning fluids are relatively aggressive towards the tubes due to the solvent.

The present disclosure is further based on the discovery that ADAS cleaning fluids can wash out the known polyurethane tubes, causing these tubes to become brittle and, under certain circumstances, cracked. It has been found that polyamides and polyolefins are more resistant to ADAS cleaning fluids than polyurethanes. As a result, the tubes according to the present disclosure are less prone to being washed out or becoming brittle, thereby solving the problem mentioned at the outset.

The cleaning fluid preferably comprises water. Advantageously, the cleaning fluid comprises an active component. The active component is preferably a solvent, more preferably an alcohol and, for example, isopropanol and/or ethanol. It is highly preferred that the cleaning fluid is a mixture, wherein the mixture comprises the water and the active component.

It is particularly preferred that the cleaning fluid is designed for use in an ADAS of a vehicle. It is preferred that the ADAS of the vehicle comprises the tube. Advantageously, the ADAS comprises several of the tubes. It is possible that the ADAS comprises tubes for transporting compressed air.

Advantageously, the ADAS is designed such that sensors of the ADAS are first cleaned with the cleaning fluid and then freed from the cleaning fluid or dirt with the compressed air.

It is possible that the tube comprises only one layer. The single layer preferably comprises a polyamide, in particular an aliphatic polyamide and most preferably PA11. The weight proportion of the polyamide or aliphatic polyamide or PA11 in the single layer is preferably at least 30%, 50%, 70%, or 90%.

Polyamides ensure that the tube has good pressure resistance and chemical resistance to the cleaning fluid. Aliphatic polyamides ensure that the plastic offers good value for money compared to aromatic polyamides. PA11 has the advantage over other aliphatic polyamides in that it has particularly good chemical resistance to the ADAS cleaning fluid. In addition, polyamides, preferably aliphatic polyamides and in particular PA11, have good chemical resistance to other fluids in the automotive sector, so that polyamides and in particular PA11 protect the tube not only from internal but also from external influences so that a single-layer tube is possible.

It is particularly preferred that the tube wall comprises an inner layer, wherein the inner layer preferably comprises the polyamide or polyolefin of the tube wall. The inner layer ensures that a layer of the tube or tube wall can be specifically adapted to the fluid to be transported, so that the properties of the tube with regard to the fluid to be transported can be optimized for ADAS cleaning fluids. It is highly preferred that the inner layer is the innermost layer of the tube. The inner layer is advantageously a maximum of 0.6 or 0.5 or 0.4 or 0.3 mm thick. This results in economical use of the sophisticated plastic of the inner layer. It is preferred that the inner layer has a layer thickness of at least 0.05 or 0.07 or 0.08 mm. This ensures that the layer is formed continuously during coextrusion.

The term “layer” preferably refers to a body that is hollow in cross-section and preferably completely circumferential. The hollow body or layer is preferably formed integrally. The term “integral” preferably refers to a single-piece body that has no internal, continuous interfaces or internal continuous boundary surfaces. The term “internal continuous boundary surfaces” preferably refers to internal boundary surfaces that completely divide a body into at least two areas that have no connection beyond the boundary surfaces. For example, the boundary surfaces of the layers of a coextruded tube are continuous internal boundary surfaces.

The term “one-piece” preferably means that the one-piece body can only be divided into two or more pieces in a destructive manner, for example by cutting. An example of one-piece construction is a preform in the form of a tube with several coextruded and materially bonded layers, which is one-piece but not integral across the entire tube wall.

For the production of an integral body, it is expedient that the body is produced from a single melt is a necessary but not a sufficient condition. It is further expedient that the body produced from a melt is not supplemented by further bodies from this melt, which in turn would create internal boundary surfaces on the overall body, so that the overall body would not be integral.

Consequently, a multilayer, coextruded tube is integrally formed in layers and is also formed in one piece across the entire tube wall or preform wall, but not integrally across the entire tube wall. A single layer of a multilayer tube, on the other hand, is integrally formed along the tube and, in particular, is completely integrally formed. The reason for this is that each of the layers is assigned to its own melt and is not separated by interfaces between them. The different layers are conveniently recognizable microscopically or by other imaging techniques, particularly at the interfaces between the layers. The term “integral” preferably encompasses bodies formed “integrally in layers” and bodies formed “completely integrally.”

It is particularly preferred that the tube is formed in one piece. It is advantageous that at least two layers and preferably all layers of the tube are connected to each other in a material-locking manner, in particular due to coextrusion. It is particularly advantageous that all layers of the tube are connected to the adjacent layer or layers in a material-locking manner. It is highly preferred that the tube is manufactured by extrusion or coextrusion.

It is advantageous that the polyamide of the tube wall or the inner layer is an aliphatic polyamide and, in particular, PA11. It is advantageous that the inner layer comprises at least 30 or 50 or 70 or 90 wt. % polyamide or aliphatic polyamide or PA11. Polyamides cause the tube to have good compressive strength and chemical resistance to the cleaning fluid. Aliphatic polyamides cause the plastic to have a good price-performance ratio compared to aromatic polyamides. PA11 has the advantage over other aliphatic polyamides in that it has very good chemical resistance and washout resistance to the ADAS cleaning fluid.

It is preferable that the polyolefin of the tube wall or the inner layer is a polypropylene, preferably a polyolefin homopolymer or polypropylene homopolymer. This results in good resistance to water and to an active component of an ADAS cleaning fluid. It is possible that the polyolefin of the tube wall or the inner layer is a polypropylene copolymer. In particular, the polyolefin, preferably polypropylene, is highly washout-resistant—comparable to PA or PA11—with respect to the ADAS cleaning fluid. In addition, the polyolefin or polypropylene offers relatively good impact strength at low temperatures. It is preferred that the inner layer comprises at least 30, 50, 70, or 90 wt % polyolefin, polypropylene, polyolefin homopolymer, polypropylene homopolymer, or polypropylene copolymer. It is very advantageous that the polyolefin or polypropylene or polyolefin homopolymer or polypropylene homopolymer of the tube wall or the inner layer is mixed with an elastomer component, for example EPDM. This allows high impact resistance.

The tube wall preferably includes an outer layer, wherein the outer layer advantageously comprises a polyamide, preferably an aliphatic polyamide, and even more preferably PA11. Polyamides, preferably aliphatic polyamides and in particular PA11, have good chemical resistance to a wide variety of fluids in the automotive sector, so that polyamides or aliphatic polyamides and in particular PA11 also protect the tube from external influences. Conveniently, the outer layer surrounds the inner layer. It is possible for the outer layer to be in contact with the inner layer. It is possible for one or more additional layers to be located between the outer layer and the inner layer. It is preferred that the outer layer is the outermost layer of the tube. Preferably, the outer layer comprises at least 20 or 30 or 50 or 70 or 90 wt. % polyamide or aliphatic polyamide or PA11. The outer layer is advantageously at most 1.0 or 0.9 or 0.8 or 0.7 or 0.6 mm thick. Advantageously, the layer thickness of the outer layer is at least 0.2, 0.5, 1.0, 1.2, 1.4, 1.6, or 1.8 mm. This ensures that the chemical and mechanical effects desired from the material are sufficiently provided.

It is possible for the tube to comprise only two layers. The two layers are preferably formed by the inner layer and the outer layer. It is highly preferred that, in the case of only two layers, the inner layer comprises the polyolefin or polypropylene of the tube wall.

It is advantageous if the tube has a carrier layer, wherein the carrier layer preferably comprises a polyamide, in particular an aliphatic polyamide and especially PA6. This results in good impact strength at low temperatures and good compressive strength, as well as good adhesion to polyamides or aliphatic polyamides or PA11. PA6 offers a price advantage over PA11. However, PA6 is less chemically resistant than PA11 to ADAS cleaning fluid and other fluids used in the automotive sector. These properties make PA6 the ideal material for the carrier layer.

It is preferable that the carrier layer surrounds the inner layer. It is possible for the carrier layer to be adjacent to the inner layer. It is possible for a further layer to be located between the carrier layer and the inner layer. Preferably, the outer layer surrounds the carrier layer. It is advantageous for the outer layer to be adjacent to the carrier layer. This results in a low-layer or easy-to-extrude structure, which in particular does not require an adhesive layer between the carrier layer and the inner layer or outer layer. Preferably, the carrier layer comprises at least 30 or 50 or 70 or 90 wt % polyamide or aliphatic polyamide or PA6. Advantageously, the layer thickness of the carrier layer is at least 0.2, 0.3, or 0.4 mm. This provides a relatively thick layer so that the carrier layer can take over a large part of the mechanical functions of the tube wall and the use of the other plastics is more economical. The layer thickness of the carrier layer is advantageously at most 1.5, 1.2, 1.0, or 0.8 mm, respectively, since otherwise the material consumption would be too high and, moreover, hardly any added value would be achieved.

According to one embodiment, the tube has a barrier layer, wherein the barrier layer preferably comprises a polyolefin and preferably polypropylene. It is possible for the barrier layer to comprise a polypropylene copolymer. It is highly preferred that the polyolefin or polypropylene of the barrier layer is a homopolymer (polyolefin homopolymer or polypropylene homopolymer). This results in good resistance or washout resistance to water and active components, and in particular to ADAS cleaning fluids. This provides a good complement to the inner layer in terms of chemical resistance and barrier effect against ADAS cleaning fluids.

It is advantageous for the barrier layer to be located outside the inner layer. It is expedient for the barrier layer to be located within the outer layer or the carrier layer. It is preferred that the barrier layer is adjacent to the inner layer or the carrier layer. It is preferred that a further layer, in particular an adhesive layer, is arranged between the barrier layer and the outer layer. It is possible that a further layer, in particular an adhesive layer, is arranged between the barrier layer and the inner layer. The barrier layer advantageously comprises at least 30, 50, 70, or 90 wt % polyolefin, polyolefin homopolymer, polypropylene, polypropylene homopolymer, or polypropylene copolymer, respectively. The layer thickness of the barrier layer is advantageously at least 0.05, 0.07, or 0.09 mm. It is preferred that the layer thickness of the barrier layer is at most 0.5, 0.4, 0.3, or 0.2 mm.

The barrier layer very preferably contains an adhesion additive in addition to the polyolefin or polypropylene or polypropylene homopolymer. An example of the adhesion additive is maleic anhydride. Another advantageous effect of the polyolefins or polypropylenes is their high washout resistance to alcoholic solutions and thus also to ADAS cleaning fluids with an alcoholic component.

The tube particularly preferably comprises an inner barrier layer and an outer barrier layer. The inner barrier layer is advantageously the barrier layer. The inner barrier layer and/or the outer barrier layer preferably comprises a polyolefin and very preferably a polypropylene. The inner barrier layer and/or outer barrier layer advantageously comprises at least 30, 50, 70, or 90 wt % polyolefin or polypropylene. The inner barrier layer and/or the outer barrier layer preferably contains an adhesion additive in addition to the polyolefin or polypropylene. For example, the adhesion additive is maleic anhydride.

According to a preferred embodiment, the carrier layer is arranged between the inner barrier layer and the outer barrier layer. It is preferred that the inner barrier layer is arranged within the carrier layer and preferably adjacent to the carrier layer. It is advantageous that the inner barrier layer is arranged outside the inner layer and preferably adjacent to the inner layer. It is preferable that the outer barrier layer is arranged outside the carrier layer and preferably adjacent to the carrier layer. It is advantageous that the outer barrier layer is arranged inside the outer layer and preferably adjacent to the outer layer. This serves to protect the carrier layer from water on both sides. The adhesion additive enables good adhesion of the two barrier layers to the carrier layer, the inner layer and/or the outer layer and reduces the number of layers required because no separate adhesive layers are needed.

Advantageously, the layer thickness of the inner barrier layer is at least 0.07 or 0.09 or 0.12 or 0.15 mm. It is preferred that the layer thickness of the inner barrier layer is at most 0.5 or 0.4 or 0.3 mm. Advantageously, the layer thickness of the outer barrier layer is at least 0.05, 0.07, or 0.09 mm, respectively. It is preferred that the layer thickness of the outer barrier layer is at most 0.5, 0.4, 0.3 or 0.2 mm, respectively.

The tube may comprise an adhesive layer, wherein the adhesive layer preferably comprises a polyolefin and more preferably a polypropylene. The adhesive layer advantageously has an adhesion additive. This results in better adhesion to the inner layer/outer layer/carrier layer/barrier layer than these layers would have to each other and thus counteracts delamination. An example of the adhesion additive is maleic anhydride. It is possible for the adhesive layer to be arranged between the inner layer on the one hand and the outer layer or carrier layer on the other hand. It is possible for the adhesive layer to be located between the inner layer on the one hand and the barrier layer on the other hand. It is possible that the adhesive layer is arranged between the outer layer or carrier layer on the one hand and the barrier layer on the other hand. It is preferred that the adhesive layer is adjacent to the barrier layer. Preferably, the adhesive layer is adjacent to the carrier layer. It is preferred that the adhesive layer is adjacent to the inner layer. According to one embodiment, the tube or tube wall comprises two adhesive layers. Preferably, the two adhesive layers enclose the barrier layer. Preferably, both adhesive layers are adjacent to the barrier layer. It is preferred that the inner of the two adhesive layers adheres to the inner layer. Advantageously, the outer of the two adhesive layers adheres to the carrier layer. The adhesive layer or adhesive layers are particularly advantageous when they are intended to bond a polyamide to a polyolefin. The adhesive layer or adhesive layers have a layer thickness of at most 0.3, 0.2, 0.15, or 0.1 mm.

Advantageously, the tube has an internal diameter ID of at least 3.0, 4.0, or 5.0 mm. This ensures sufficient media transport. The clear inner diameter ID of the tube is advantageously no more than 30, 20, or 15 mm. Otherwise, the tube would be too bulky. It is preferred that the tube wall has a thickness S of at least 0.6, 0.7, or 0.8 mm. This makes the tube or tube wall sufficiently pressure-resistant. It is preferable that the tube wall has a thickness of no more than 3.0 or 2.5 or 2.0 or 1.5 mm. Otherwise, too much material would be used.

Preferably, the tube comprises a connecting section and/or a main section in the axial direction. This serves to optimize the flow conditions by providing different tube sections with, in particular, different clear inner diameters in the axial direction. The connecting section preferably has a larger clear inner diameter (smallest inner diameter) than the main section. It is possible for the main section to be corrugated. The term “corrugated” refers, for example, to sinusoidal, rectangular, or sawtooth-shaped tube walls in longitudinal section. It is possible that an intermediate section is arranged between the main section and the connecting section. The intermediate section preferably has a smaller clear internal diameter than the connecting section. In particular, the intermediate section may be non-corrugated. The connecting section is preferably designed to accommodate a nozzle. By inserting the nozzle into the connecting section, the clear internal diameter of the nozzle corresponds approximately to the clear internal diameter of the main section. As a result, largely uniform clear internal diameters are achieved in the tube and pressure losses are minimized.

The task mentioned at the beginning is solved by using a tube according to the present disclosure for transporting a cleaning fluid, in particular a tube according to one of the above aspects, wherein the cleaning fluid preferably comprises water, wherein the cleaning fluid preferably comprises an active component, more preferably a solvent, and even more preferably an alcohol. The cleaning fluid is preferably a component of an ADAS in a vehicle.

### BRIEF DESCRIPTION OF THE DRAWINGS

The present disclosure is explained below with reference to five embodiments of the present disclosure and with the aid of six figures.

FIG. 1 shows a perspective view of a tube of a first embodiment of the present disclosure,

FIG. 2 shows a perspective view of a tube of a second embodiment of the present disclosure,

FIG. 3 shows a perspective view of a tube of a third embodiment of the present disclosure,

FIG. 4 shows a perspective view of a tube of a fourth embodiment of the present disclosure,

FIG. 5 shows a perspective view of a tube of a fifth embodiment of the present disclosure, and

FIG. 6 shows a longitudinal section along an axial section of at least one of the embodiments of FIGS. 1 to 5.

### DETAILED DESCRIPTION

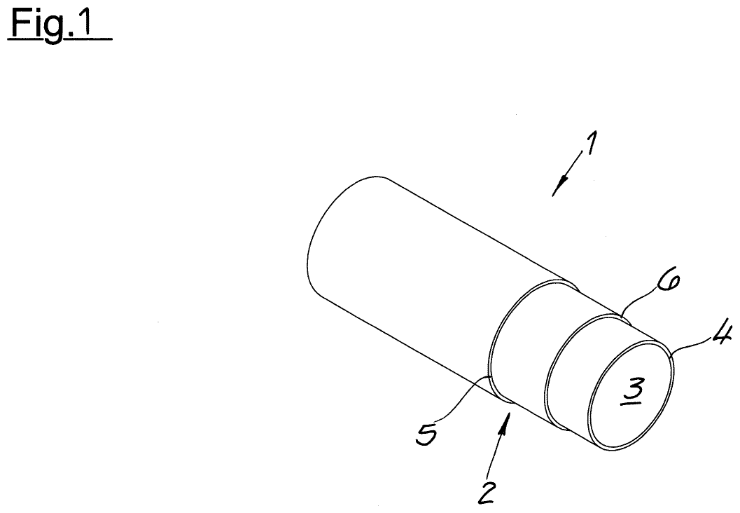

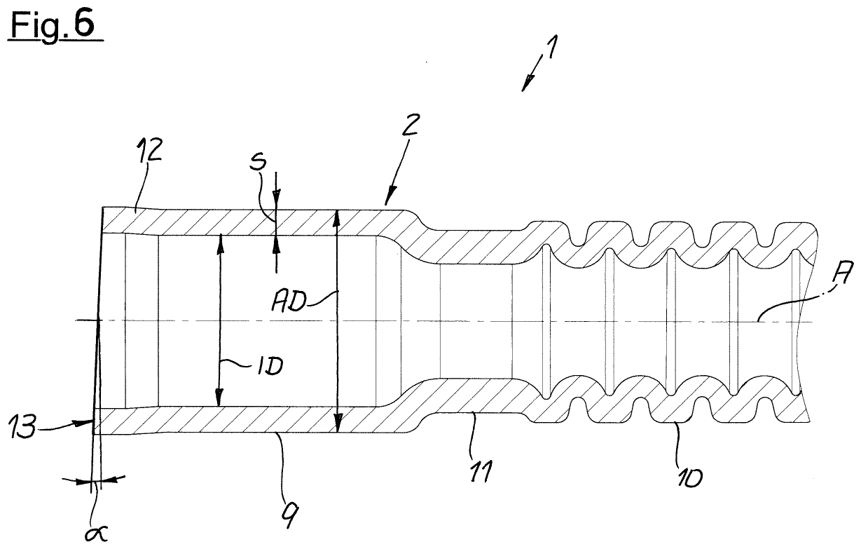

FIGS. 1 to 5 each show a tube 1 with a tube wall 2 enclosing a lumen 3. In the cases of FIGS. 1 to 5, the tube wall 2 is multi-layered, whereby the different layers 4, 5, 6, 7, 8 are shown staggered relative to each other solely for the sake of clarity. The longitudinal section in FIG. 6 shows an axial section of the tubes 1 from FIGS. 1 to 5, as the rather thin layers have been omitted in FIG. 6 for the sake of clarity. FIG. 6 may therefore represent a single-layer tube or a multi-layer tube, for example a tube 1 according to one of FIGS. 1 to 5.

It is preferred that the tubes 1 are used to transport a cleaning fluid. The cleaning fluid preferably comprises water. Advantageously, the cleaning fluid has an active component. The active component is preferably a solvent and particularly preferably an alcohol. The alcohol may be isopropanol or ethanol. Due to the preferred active component, the cleaning fluid is relatively aggressive towards the tubes 1, so that the tubes 1 are specially adapted to the application of transporting the cleaning fluid.

The cleaning fluid is advantageously used in or on a vehicle. It is preferred that the cleaning fluid is used for cleaning sensors of a vehicle. The sensors are preferably part of an Advanced Driver Assistance System (ADAS). The ADAS advantageously comprises a compressed air system for removing the cleaning fluid from the sensors. The rather complex ADAS is not shown here for reasons of clarity.

The tube 1 of the first embodiment in FIG. 1 preferably comprises an inner layer 4, an outer layer 5 and/or a carrier layer 6. The inner layer 4 advantageously comprises a polyamide and, in particular, a PA11. The outer layer 5 preferably comprises a polyamide and, in particular, a PA11. It is advantageous for the carrier layer 6 to comprise a polyamide, preferably PA6. In this embodiment, the inner layer 4 and the outer layer 5 each have a layer thickness of 0.2 mm. In contrast, the layer thickness of the carrier layer 6 of the first embodiment is 0.6 mm. The PA6 of the carrier layer 6 gives the tube 1 good mechanical properties and, in particular, compressive strength and impact resistance. The PA11 of the inner layer 4 is highly resistant to washing out by the ADAS cleaning fluid, so that the outer layers 6, 5 are protected from the cleaning fluid. A layer thickness of 0.2 mm is sufficient for this protection.

The outer layer 5 of the tube 1 in FIG. 1 is also relatively thin, but offers good pressure resistance and, above all, good chemical resistance to various fluids in the automotive sector. This protects the inner layers and, especially, the carrier layer 6. The carrier layer 6 can therefore be made relatively thick, which means that the mass of the plastic in this tube is distributed across the carrier layer 6 and thus across the PA 6. This creates a correspondingly cost-effective multi-layer structure. In addition, all three layers are relatively pressure-resistant, enabling them to withstand the volume changes of the water in the cleaning fluid.

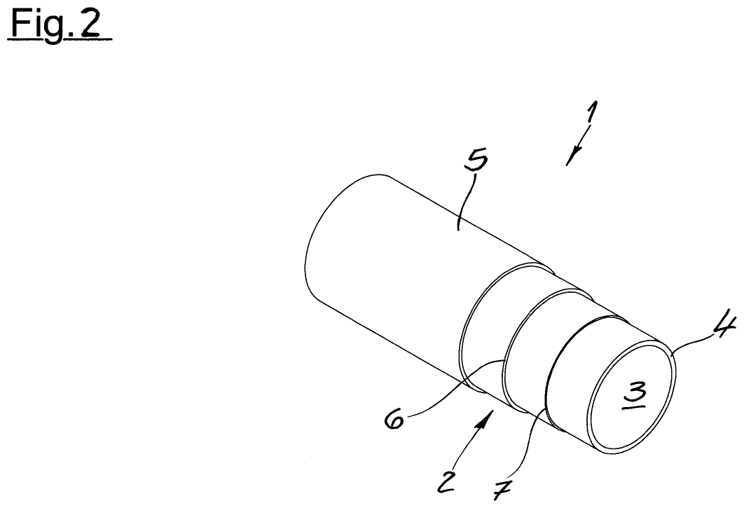

The tube 1 of the second embodiment according to FIG. 2 has the same inner layer 4 and the same outer layer 5 as the first embodiment. In addition, the tube 1 preferably comprises a carrier layer 6, wherein the carrier layer 6 of this embodiment is enclosed by the outer layer 5 and preferably rests against the outer layer 5. The carrier layer 6 preferably comprises a polyamide and, in particular, PA6. However, the carrier layer 6 of the second embodiment is somewhat thinner than in the first embodiment, with a thickness of 0.4 mm.

Advantageously, the tube 1 of the second embodiment according to FIG. 2 comprises a barrier layer 7. The barrier layer 7 preferably comprises a polyolefin and, in particular, a polypropylene. It is preferred that the barrier layer 7 has an adhesion additive. The adhesion additive can be, for example, maleic anhydride. The barrier layer 7 may have a layer thickness of, for example, 0.2 mm. The polypropylene of the barrier layer 7 complements the PA 11 of the inner layer 4 with regard to shielding the outer subsequent layers 6, 5 and, in particular, protects the hygroscopic carrier layer 6 comprising PA6 from the water of the cleaning fluid. Due to the polyolefin or polypropylene in the barrier layer 7, it is advantageous to provide the adhesion additive in the barrier layer 7, because this causes the barrier layer 7 to adhere better to the carrier layer 6 and to the inner layer 4.

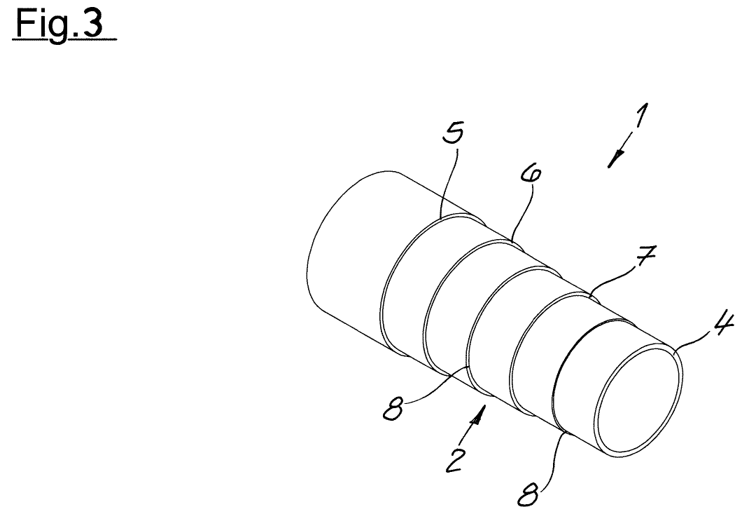

The tube 1 of the third embodiment according to FIG. 3 has the same outer layer 5 and the same carrier layer 6 as the second embodiment. The tube 1 of the third embodiment preferably has an inner layer 4 comprising a polyamide and, in particular, PA11. In this embodiment, the inner layer 4 has a layer thickness of only 0.1 mm. It is preferred that the tube 1 has a barrier layer 7. The barrier layer 7 preferably comprises a polyolefin and, in particular, a polypropylene. The barrier layer 7 may have a layer thickness of 0.1 mm.

According to FIG. 3, the tube 1 preferably comprises an outer adhesive layer 8, which preferably surrounds the barrier layer 7 and further preferably adheres to the barrier layer 7. Advantageously, the tube 1 comprises an inner adhesive layer 8, which is preferably enclosed by the barrier layer 7 and further preferably rests against the barrier layer 7. The two adhesive layers 8 of this embodiment preferably have an adhesion additive, wherein the adhesion additive may be maleic anhydride. This ensures that the PP composite 8, 7, 8 adheres well to both the inner layer 4 and the carrier layer 6. The polyolefin or polypropylene of the barrier layer 7 or the PP composite 8, 7, 8 complements the inner layer 4 with regard to the barrier effect against the cleaning fluid.

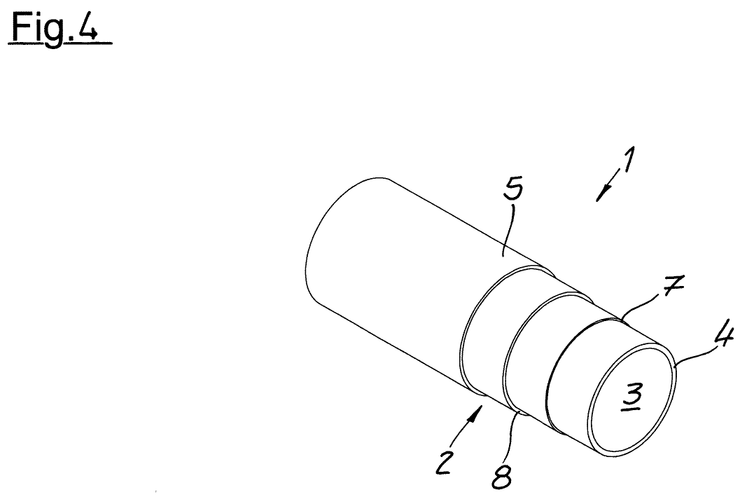

The tube 1 of the fourth embodiment according to FIG. 4 has an inner layer 4 and an outer layer 5. The outer layer 5 advantageously comprises a polyamide and, in particular, PA11. The outer layer 5 of this embodiment may have a layer thickness of 0.5 mm. The inner layer 4 of the fourth embodiment may comprise a polyolefin, preferably a polypropylene and particularly preferably a polypropylene-elastomer component mixture. The layer thickness of the inner layer 4 may be 0.2 mm. It is preferred that the tube 1 of the fourth embodiment comprises a barrier layer 7. The barrier layer 7 of this embodiment advantageously comprises a polyolefin and preferably a polypropylene. The barrier layer 7 advantageously comprises maleic anhydride. The barrier layer 7 may have a layer thickness of 0.2 mm.

It is preferred that the tube 1 of the fourth embodiment according to FIG. 4 comprises an adhesive layer 8. The adhesive layer 8 may comprise a polyolefin and, in particular, a polypropylene. It is preferred that the adhesive layer 8 of the fourth embodiment comprises an adhesion additive and, in particular, maleic anhydride. It is advantageous that the adhesive layer 8 is arranged between the outer layer 5 and the barrier layer 7 and preferably adheres to the outer layer 5 and to the barrier layer 7. This ensures that the polypropylene composite 4, 7, 8 adheres well to the outer layer 5. The inner layer 4 comprising PP-B and the barrier layer 7 comprising PP-R complement each other well in terms of their barrier effect against ADAS cleaning fluids. In the fourth embodiment, sufficient compressive strength is provided primarily by the outer layer 5. The advantage of the relatively thick outer layer 5 is also that PA11 can be produced from bio-based materials.

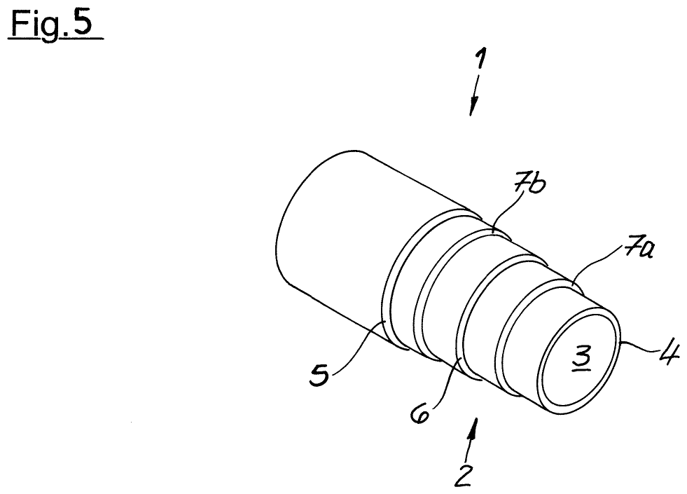

FIG. 5 shows a tube 1 of a particularly preferred fifth embodiment. The tube 1 preferably comprises, from the inside to the outside, an inner layer 4, an inner barrier layer 7a, a carrier layer 6, an outer barrier layer 7b and/or an outer layer 5. The inner layer 4 advantageously comprises a polyamide, in particular PA11, or a polyolefin, preferably polypropylene. The inner layer 4 advantageously comprises an elastomer component, preferably in addition to the polyolefin or polypropylene.

The outer layer 5 of the fifth embodiment preferably comprises a polyamide, in particular PA11. It is advantageous for the carrier layer 6 to comprise a polyamide, preferably PA6. The inner barrier layer 7a and/or the outer barrier layer 7b preferably comprises a polyolefin and, in particular, a polypropylene. It is preferred that the inner barrier layer 7a and/or the outer barrier layer 7b comprises an adhesion additive. The adhesion additive may be, in particular, maleic anhydride.

The polyolefin or polypropylene of the outer barrier layer 7b in FIG. 5 complements the PA 11 of the outer layer 5 in terms of shielding the carrier layer 6 and protects it from water in the ambient humidity. Due to the polyolefin or polypropylene in the outer barrier layer 7b, it is advantageous to provide the adhesion additive in the outer barrier layer 7b, because this allows the outer barrier layer 7b to adhere better to the carrier layer 6 and to the outer layer 5. The outer barrier layer 7b therefore performs a similar function to the inner barrier layer 7a in the embodiment shown in FIG. 2, but relates to the protective effect towards the outside.

The inner layer 4 may have a layer thickness of 0.3 mm in the case of PA11 and 0.2 mm in the case of polypropylene. The outer layer 5 preferably has a layer thickness of 0.2 mm in the case of an inner layer 4 comprising PA11 and preferably a layer thickness of 0.3 mm in the case of an inner layer 4 comprising polypropylene. The inner barrier layer 7a of the embodiment according to FIG. 5 may have a layer thickness of 0.2 mm. The carrier layer 6 advantageously has a layer thickness of 0.2 mm. The outer barrier layer 7b may have a layer thickness of 0.1 mm, which is preferred due to the lower influence of water from outside.

According to FIG. 6, the tube in 1, preferably at least one of the tubes 1 of FIGS. 1 to 5, advantageously has a connecting section 9 and/or a main section 10. The main section 10 may be corrugated. It is preferred that the tube 1 comprises an intermediate section 11 which is arranged between the connecting section 9 and the main section 10. Advantageously, a clear inner diameter ID of the connecting section 9 is greater than a clear inner diameter ID of the main section 10 and/or of the connecting section 11.

For example, a connector not shown in FIG. 6 can be inserted into the connecting section 9 so that a clear inner diameter of the connector essentially corresponds to the smallest inner diameter of the main section 10. This provides an approximately constant internal diameter over the axial extension of the tube 1, so that no unnecessary pressure losses occur. The tube wall 2 of the tube 1 according to FIG. 6 may have a thickness S, which in this embodiment corresponds to 1.2 mm. The inner diameter ID in the connecting section 9 may be 8 mm, so that the outer diameter in the connecting section 9 is 10.4 mm.

The tube 1 may have an insertion section 12 as shown in FIG. 6. The insertion section 12 may widen radially toward an end face 13 of the tube 1. The insertion section 12 is preferably arranged between the connecting section 9 and the end face 13. The widening of the outer diameter AD by the insertion section 12 may be, for example, 0.1 mm relative to the connecting section 9. The end face 13 of the tube 1 is typically formed by a cutting process in which the tube 1 is cut to a desired length. The end face 13 may be slanted and, in particular, deviate from a purely radial alignment in the longitudinal section and produce a cutting angle a >0. The cutting angle α may be 2°, for example.

### LIST OF REFERENCE SYMBOLS

1 Tube
2 Tube wall
3 Lumen
4 Inner layer
5 Outer layer
6 Carrier layer
7 Barrier layer
7a Inner barrier layer
7b Outer barrier layer
8 Adhesive layer
9 Connecting section
10 Main section
11 Intermediate section
12 Insertion section
13 End face
A Longitudinal axis
ID Inner diameter
AD Outer diameter
S Thickness of the tube wall 2
α Cutting Angle

1. A tube for guiding a cleaning fluid, wherein the tube has a tube wall, wherein the tube wall encloses a lumen, wherein the tube wall comprises a polyamide and/or a polyolefin.

2. The tube acing to claim 1, wherein the tube wall comprises an inner layer, wherein the inner layer comprises the polyamide and/or polyolefin of the tube wall.

3. The tube according to claim 2, wherein the polyamide and/or polyolefin of the tube wall or the inner layer is an aliphatic polyamide.

4. The tube according to claim 2, wherein the polyamide and/or polyolefin of the tube wall or the inner layer is a polypropylene.

5. The tube according to claim 2, wherein the polyolefin and/or polypropylene of the tube wall or the inner layer is mixed with an elastomer component.

6. The tube according to claim 1, wherein the tube wall comprises an outer layer, wherein the outer layer comprises a polyamide.

7. The tube according to claim 1, wherein the tube has a carrier layer, wherein the carrier layer comprises a polyamide.

8. The tube according to claim 1, wherein the tube or the tube wall has a barrier layer, wherein the barrier layer comprises a polypropylene.

9. The tube according to claim 1, wherein the tube or the tube wall comprises an inner barrier layer and an outer barrier layer, wherein the carrier layer is arranged between the inner barrier layer and the outer barrier layer.

10. Use of the tube according to claim 1 for transporting a cleaning fluid, wherein the cleaning fluid comprises water a solvent.

11. The use according to claim 10, wherein the solvent comprises an alcohol.

12. The tube according to claim 1, wherein the polyamide and/or polyolefin of the tube wall or the inner layer is PA11.

13. The tube according to claim 6, wherein the outer layer comprises an aliphatic polyamide.

14. The tube according to claim 6, wherein the outer layer comprises PA11.

15. The tube according to claim 7, wherein the carrier layer comprises an aliphatic polyamide.

16. The tube according to claim 7, wherein the carrier layer comprises PA6.

17. The tube according to claim 8, wherein the barrier layer comprises maleic anhydride.
